(19) United States
(12) Patent Application Publication
(10) Pub. No.: US 2026/0212163 A1
(43) Pub. Date: Jul. 23, 2026

(54) METHOD AND SYSTEM FOR IMPROVING OVERALL QUALITY AND SCOPE OF DISTINCT ARTIFICIAL INTELLIGENCE AND MACHINE LEARNING MODLES

(71) Applicant: JPMorgan Chase Bank, N.A., New York, NY (US)

(72) Inventors: Souradip CHAKRABORTY, Hyattsville, MD (US); Sujay BHATT, Fresh Meadows, NY (US); Udari Madhushani SEHWAG, Jersey City, NJ (US); Alec KOPPEL, New York, NY (US); Sumitra GANESH, Short Hills, NJ (US)

(73) Assignee: JPMorgan Chase Bank, N.A., New York, NY (US)

(21) Appl. No.: 19/029,617

(22) Filed: Jan. 17, 2025

(51) Int. Cl. G06N 3/0475; G06N 3/045; G06N 3/092

(52) U.S. Cl. CPC G06N 3/0475; G06N 3/045; G06N 3/092

(57) ABSTRACT

A system is presented that optimally integrates a plurality of distinct artificial intelligence and machine learning (AI/ML) models into a cohesive AI/ML paradigm that improves an overall quality and scope of the plurality of distinct AI/ML models. The system may be configured to receive an input via an interface of at least one processor; instantiate a tokenized output of the at least one processor; establish, with the at least one processor, a plurality of connections that respectively correspond to and communicate with each AI/ML model from among the plurality of distinct AI/ML models; perform, by the at least one processor, an iterative sequence that utilizes the plurality of connections to populate the tokenized output based on the input; and transmit the tokenized output to the interface.

### BACKGROUND

### 1. Field

This disclosure generally relates to artificial intelligence and machine learning models and, more particularly, to a method, system, and computer-readable medium for an integration paradigm that improves an overall quality and scope of distinct artificial intelligence and machine learning models.

### 2. Background

The popularity of artificial intelligence (AI) technology has grown exponentially over the past few years due to recent advancements in areas including generative AI (such as large language model (LLM)-based generative AI systems, for example). These recent advancements have made leaps and bounds in propelling the technology's ability to electronically “learn,” converse and create content (such as music, art and literature, to name a few) at levels that often exceed human abilities.

However, today's AI systems cannot handle more than a small number of tasks. Additionally, due to the increasingly large number of AI options that are currently available, it has become impossible for an AI user to figure out which AI system is the best option for a given task, without engaging in an extensive process of trial and error. Unfortunately, such extensive processing requires significant electronic resources, which thwarts conventional conservation efforts.

Therefore, there is a need in in the field of the present disclosure, for a technological improvement that addresses these drawbacks and improves the technology by providing a system that conserves resources by expanding the range of tasks that an AI system can handle and by eliminating the need to engage in an extensive trial and error process to do so.

Accordingly, the approach disclosed herein is presented to improve the field of the present disclosure by providing it with a technical solution to the above-mentioned conservation and narrow applicability drawbacks of existing AI systems.

### SUMMARY

The present disclosure, through one or more of its various aspects, embodiments, and/or specific features or sub-component, provides, inter alia, various systems, servers, devices, methods, media, programs and platforms for integrating distinct artificial intelligence and machine learning (AI/ML) models into a cohesive AI/ML paradigm that improves their overall quality and scope.

According to an aspect of the invention, a method is provided that optimally integrates a plurality of distinct AI/ML models into a cohesive AI/ML paradigm that improves an overall quality and scope of the plurality of distinct AI/ML models. The method may comprise: receiving an input via an interface of at least one processor; instantiating a tokenized output of the at least one processor; establishing, with the at least one processor, a plurality of connections that respectively correspond to and communicate with each AI/ML model from among the plurality of distinct AI/ML models; performing, by the at least one processor, an iterative sequence that utilizes the plurality of connections to populate the tokenized output based on the input; and transmitting the tokenized output to the interface.

In the method, the iterative sequence may comprise: providing, via each connection from among the plurality of connections, the input and the tokenized output to each AI/ML model from among the plurality of distinct AI/ML models; obtaining, from each AI/ML model via a respectively corresponding connection from among the plurality of connections, a respectively corresponding token of a respectively corresponding tokenized response that has been generated, in response to the providing, by a respectively corresponding AI/ML model from among the plurality of distinct AI/ML models; evaluating the input, the tokenized output, and a set of tokens that comprises each respectively corresponding token, to determine a most qualified token from among the set of tokens; and updating, by appending the most qualified token to, the tokenized output.

The method may further comprise, when the at least one processor determines that the updating does not complete the tokenized output, re-performing the iterative sequence until the at least one processor determines that the updating completes the tokenized output. In the method, the iterative sequence may further comprise analyzing the input, the tokenized output, and each respectively corresponding tokenized response to determine, via the at least one processor, whether the updating completes the tokenized output.

In the method, the iterative sequence may further comprise responding to each updating by transmitting, to the interface, at least one from among the most qualified token and the tokenized output.

In the method, each respectively corresponding tokenized response may be at least textual, and each respectively corresponding token may comprise a respectively corresponding textual term from among the respectively corresponding tokenized response.

In the method, when the most qualified token comprises an end statement, the updating may complete the tokenized output.

In the method, the evaluating may comprise utilizing a reinforcement learning mechanism to determine, for each token from among the set of tokens, a respectively corresponding qualitative value of the token.

In the method, the reinforcement learning mechanism may determine each respectively corresponding qualitative value by performing a quantifying function (Q*) that is defined by the equation:

$$\text{?} ( s , a ) = \text{?} [ \text{?} ] ,$$

$$\text{?} \text{indicates text missing or illegible when filed}$$

wherein j represents a jth instance of Q* from among a plurality of instances that respectively correspond to the plurality of distinct AI/ML models, πⱼ represents a jth AI/ML model from among the plurality of distinct AI/ML models, s represents the tokenized output, a represents a proposed token of a jth tokenized response that has been generated by the jth AI/ML model in response to the providing, [symbol] represents an expectation operator, r* represents an accuracy of an optimal response to the input, τ represents a trajectory of tuples that comprise at least one state, at least one action and at least one reward, and ρⱼ represents a distribution of τ.

In the method, the plurality of distinct AI/ML models may comprise at least one large language model (LLM).

The method may further comprise determining, based on the input, the plurality of distinct AI/ML models.

According to another aspect of the present invention, a system is provided that optimally integrates a plurality of distinct artificial intelligence and machine learning (AI/ML) models into a cohesive AI/ML paradigm that improves an overall quality and scope of the plurality of distinct AI/ML models. The system may comprise a processor that is coupled to an interface, and memory storing instructions that, when executed by the processor, cause the processor to perform operations. In the system, the operations may comprise receiving an input via the interface; instantiating a tokenized output; establishing a plurality of connections that respectively correspond to and communicate with each AI/ML model from among the plurality of distinct AI/ML models; performing an iterative sequence that utilizes the plurality of connections to populate the tokenized output based on the input; and transmitting the tokenized output to the interface.

In the system, when executed by the processor, the instructions may cause the iterative sequence to comprise: providing, via each connection from among the plurality of connections, the input and the tokenized output to each AI/ML model from among the plurality of distinct AI/ML models; obtaining, from each AI/ML model via a respectively corresponding connection from among the plurality of connections, a respectively corresponding token of a respectively corresponding tokenized response that has been generated, in response to the providing, by a respectively corresponding AI/ML model from among the plurality of distinct AI/ML models; evaluating the input, the tokenized output, and a set of tokens that comprises each respectively corresponding token, to determine a most qualified token from among the set of tokens; and updating, by appending the most qualified token to, the tokenized output.

In the system, when executed, the instructions may cause the processor to perform further operations comprising, when the at least one processor determines that the updating does not complete the tokenized output, re-performing the iterative sequence until the at least one processor determines that the updating completes the tokenized output. In the system, the instructions may cause the iterative sequence to further comprise analyzing the input, the tokenized output, and each respectively corresponding tokenized response to determine, via the at least one processor, whether the updating completes the tokenized output.

In the system, when executed by the processor, the instructions may cause the iterative sequence to further comprise responding to each updating by transmitting, to the interface, at least one from among the most qualified token and the tokenized output.

In the system, when executed by the processor, the instructions may cause: each respectively corresponding tokenized response to be at least textual, and each respectively corresponding token to comprise a respectively corresponding textual term of the respectively corresponding tokenized response.

In the system, when the instructions are executed by the processor, the updating may complete the tokenized output when the most qualified token comprises an end statement.

In the system, when the instructions are executed by the processor, the evaluating may comprise utilizing a reinforcement learning mechanism to determine, for each token from among the set of tokens, a respectively corresponding qualitative value of the token.

In the system, when the instructions are executed by the processor, the reinforcement learning mechanism may determine each respectively corresponding qualitative value by performing a quantifying function (Q*) that is defined by the equation:

$$\text{?} ( s , a ) = \text{?} [ \text{?} ] ,$$

$$\text{?} \text{indicates text missing or illegible when filed}$$

wherein j represents a jth instance of Q* from among a plurality of instances that respectively correspond to the plurality of distinct AI/ML models, πⱼ represents a jth AI/ML model from among the plurality of distinct AI/ML models, s represents the tokenized output, a represents a proposed token of a jth tokenized response that has been generated by the jth AI/ML model in response to the providing, [symbol] represents an expectation operator, r* represents an accuracy of an optimal response to the input, τ represents a trajectory of tuples that comprise at least one state, at least one action and at least one reward, and ρⱼ represents a distribution of τ.

In the system, the plurality of distinct AI/ML models may comprise at least one large language model (LLM).

In the system, when executed, the instructions may cause the processor to perform further operations comprising determining, based on the input, the plurality of distinct AI/ML models.

According to yet another aspect of the present disclosure, a non-transitory computer-readable medium is presented that optimally integrates a plurality of distinct artificial intelligence and machine learning (AI/ML) models into a cohesive AI/ML paradigm that improves an overall quality and scope of the plurality of distinct AI/ML models. The computer-readable medium may store instructions that, when executed by a processor, cause the processor to perform operations comprising: receiving an input via the interface; instantiating a tokenized output; establishing a plurality of connections that respectively correspond to and communicate with each AI/ML model from among the plurality of distinct AI/ML models; performing an iterative sequence that utilizes the plurality of connections to populate the tokenized output based on the input; and transmitting the tokenized output to the interface.

In the computer-readable medium, when executed by the processor, the instructions may cause the iterative sequence to comprise: providing, via each connection from among the plurality of connections, the input and the tokenized output to each AI/ML model from among the plurality of distinct AI/ML models; obtaining, from each AI/ML model via a respectively corresponding connection from among the plurality of connections, a respectively corresponding token of a respectively corresponding tokenized response that has been generated, in response to the providing, by a respectively corresponding AI/ML model from among the plurality of distinct AI/ML models; evaluating the input, the tokenized output, and a set of tokens that comprises each respectively corresponding token, to determine a most qualified token from among the set of tokens; and updating, by appending the most qualified token to, the tokenized output.

In the computer-readable medium, when executed, the instructions may cause the processor to perform further operations comprising: when the at least one processor determines that the updating does not complete the tokenized output, re-performing the iterative sequence until the at least one processor determines that the updating completes the tokenized output. In the computer-readable medium, the instructions may cause the iterative sequence to further comprise analyzing the input, the tokenized output, and each respectively corresponding tokenized response to determine, via the at least one processor, whether the updating completes the tokenized output.

In the computer-readable medium, when executed by the processor, the instructions may cause the iterative sequence to further comprise responding to each updating by transmitting, to the interface, at least one from among the most qualified token and the tokenized output.

In the computer-readable medium, when executed by the processor, the instructions may cause: each respectively corresponding tokenized response to be at least textual, and each respectively corresponding token to comprise a respectively corresponding textual term of the respectively corresponding tokenized response.

In the computer-readable medium, when the instructions are executed by the processor, the updating may complete the tokenized output when the most qualified token comprises an end statement.

In the computer-readable medium, when the instructions are executed by the processor, the evaluating may comprise utilizing a reinforcement learning mechanism to determine, for each token from among the set of tokens, a respectively corresponding qualitative value of the token.

In the computer-readable medium, when the instructions are executed by the processor, the reinforcement learning mechanism may determine each respectively corresponding qualitative value by performing a quantifying function (Q*) that is defined by the equation:

$$\text{?} ( s , a ) = \text{?} [ \text{?} ] ,$$

$$\text{?} \text{indicates text missing or illegible when filed}$$

wherein j represents a jth instance of Q* from among a plurality of instances that respectively correspond to the plurality of distinct AI/ML models, πⱼ represents a jth AI/ML model from among the plurality of distinct AI/ML models, s represents the tokenized output, a represents a proposed token of a jth tokenized response that has been generated by the jth AI/ML model in response to the providing, [symbol] represents an expectation operator, r* represents an accuracy of an optimal response to the input, τ represents a trajectory of tuples that comprise at least one state, at least one action and at least one reward, and ρⱼ represents a distribution of τ.

In the computer-readable medium, the plurality of distinct AI/ML models may comprise at least one large language model (LLM).

In the computer-readable medium, when executed, the instructions may cause the processor to perform further operations comprising determining, based on the input, the plurality of distinct AI/ML models.

Accordingly, the invention disclosed herein provides a novel approach that integrates distinct AI/ML models into a cohesive AI/ML paradigm that improves their overall quality and scope.

### BRIEF DESCRIPTION OF THE DRAWINGS

The present disclosure is further described in the detailed description which follows, in reference to the noted plurality of drawings, by way of non-limiting examples of the present disclosure, in which like characters represent like elements throughout the several views of the drawings.

FIG. 1 depicts a diagram of computer system, according to an embodiment.

FIG. 2 depicts a diagram of an environment for implementing a multi-AI/ML model integration tool, according to an embodiment.

FIG. 3 depicts a diagram of a perspective of an environment that is configured to implement a multi-AI/ML model integration tool, according to an embodiment.

FIG. 4 depicts a flowchart of a process for implementing a multi-AI/ML model integration tool, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out operations necessary to implement the methods of the examples of this technology that are described and illustrated herein.

As described in further detail below, the herein-disclosed technology (which may include artificial intelligence and machine learning (AI/ML) as well as a multi-AI/ML integration tool) improves an overall quality and scope of distinct AI/ML models by integrating them into a cohesive AI/ML paradigm.

Accordingly, by employing the herein-disclosed technique to integrate distinct AI/ML technologies into a cohesive AI/ML paradigm and thereby improve their overall quality and scope, this technique provides a much-needed technical improvement to existing technology, namely AI/ML technology.

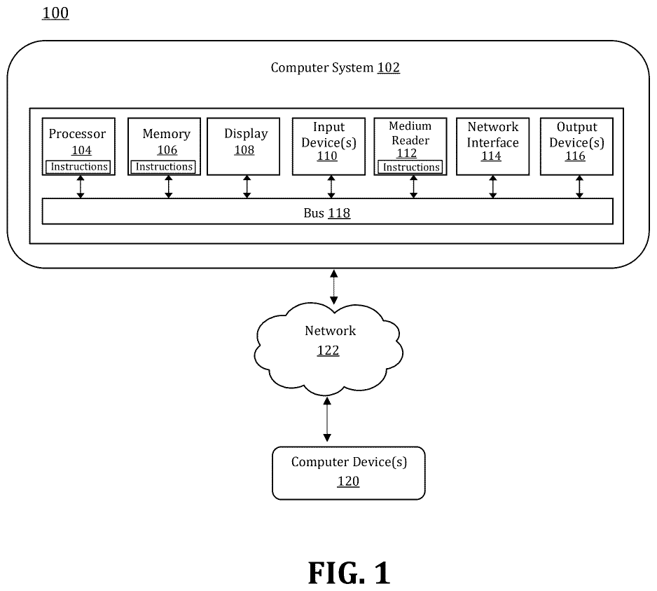

FIG. 1 is a system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for longer than a transitory period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely examples and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing a multi-AI/ML model integration tool that integrates distinct AI/ML models into a cohesive AI/ML paradigm that improves their overall quality and scope.

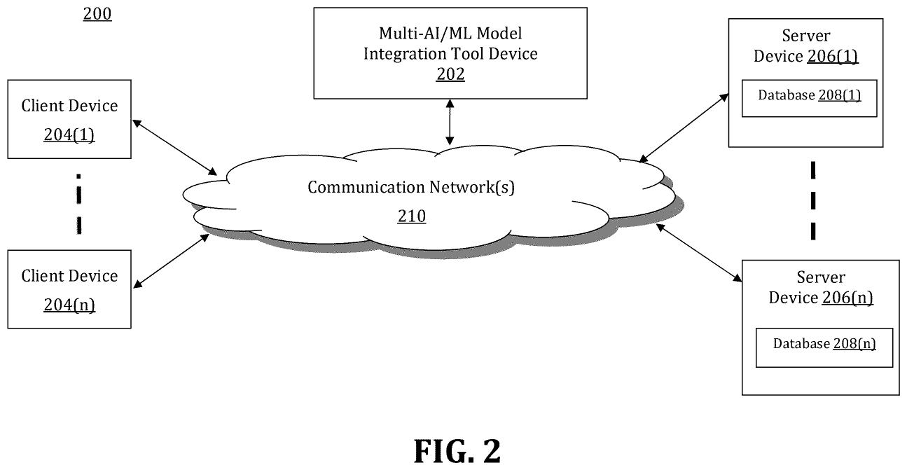

Referring to FIG. 2, a schematic of a network environment 200 for implementing a multi-AI/ML model integration tool. In an embodiment, the multi-AI/ML model integration tool may be implemented on any networked computer platform, such as, for example, a personal computer (PC).

A method for integrating distinct AI/ML models into a cohesive AI/ML paradigm that improves their overall quality and scope, may be implemented by a multi-AI/ML model integration tool (MMIT) device 202. The MMIT device 202 may be the same or similar to the computer system 102 as described with respect to FIG. 1. The MMIT device 202 may be a rack-mounted server in a datacenter, an embedded microcontroller (MCU) in an electronic device, or another type of headless system, which is a computer system or device that is configured to operate without a monitor, keyboard and mouse. The MMIT device 202 may store one or more applications that can include executable instructions that, when executed by the MMIT device 202, cause the MMIT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MMIT device 202 itself, may be located in virtual server(s) running in a cloud-based computing environment rather than being tied to one or more specific physical network computing devices. Also, the application(s) may be running in one or more virtual machines (VMs) executing on the MMIT device 202. Additionally, in one or more embodiments of this technology, virtual machine(s) running on the MMIT device 202 may be managed or supervised by a hypervisor.

In the network environment 200 of FIG. 2, the MMIT device 202 is coupled to a plurality of client devices 204(1)-204 (n), and also to a plurality of server devices 206(1)-206 (n) that hosts a plurality of databases 208(1)-208 (n) via communication network(s) 210. A communication interface of the MMIT device 202, such as the network interface 114 of the computer system 102 of FIG. 1, operatively couples and communicates between the MMIT device 202, the client devices 204(1)-204 (n), and/or the server devices 206(1)-206 (n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MMIT device 202, the client devices 204(1)-204 (n), and/or the server devices 206(1)-206 (n) may be coupled together via other topologies. Additionally, the network environment 200 may include other network devices such as one or more routers and/or switches, for example, which are well known in the art and thus will not be described herein. This technology provides a number of advantages including methods, computer readable media, and MMIT devices that implement a method for a multi-AI/ML model integration tool that improves an overall quality and scope of distinct AI/ML models by integrating them into a cohesive AI/ML paradigm.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. For the purposes of the present disclosure, it should be noted that: the term “remote” may refer to a “physical” and/or “virtual” remoteness; and the term “local” may refer to a “physical” and/or “virtual” locale.

The MMIT device 202 may be a standalone device or integrated with one or more other devices or apparatuses, such as one or more of the server devices 206(1)-206 (n), for example. In one particular example, the MMIT device 202 may include or be hosted by one of the server devices 206(1)-206 (n), and other arrangements are also possible. As another example, the MMIT device 202 may be integrated with one or more other devices or apparatuses, such as one or more of the client devices 204(1)-204 (n). Moreover, one or more of the devices of the MMIT device 202 may be in a same or a different communication network including one or more public, private, or cloud networks, for example.

The plurality of server devices 206(1)-206 (n) may be the same or similar to the computer system 102 or the computer device 120 as described with respect to FIG. 1, including any features or combination of features described with respect thereto. For example, any of the server devices 206(1)-206 (n) may include, among other features, one or more processors, memories and communication interfaces, which are coupled together by at least one bus or other communication link, although other numbers and/or types of network devices may be used. The server devices 206(1)-206 (n) in this example may process requests received from the MMIT device 202 via the communication network(s) 210 according to an HTTP-based and/or JavaScript Object Notation (JSON) protocol, for example, although other protocols may also be used.

The server devices 206(1)-206 (n) may be hardware or software or may represent a system with multiple servers in a pool, which may include internal or external networks. The server devices 206(1)-206 (n) hosts the databases 208(1)-208 (n) that are configured to store data.

Although the server devices 206(1)-206 (n) are illustrated as single devices, one or more actions of each of the server devices 206(1)-206 (n) may be distributed across one or more distinct network computing devices that together comprise one or more of the server devices 206(1)-206 (n). Moreover, the server devices 206(1)-206 (n) are not limited to a particular configuration. Thus, the server devices 206(1)-206 (n) may contain a plurality of network computing devices that operate using a master/slave approach, whereby one of the network computing devices of the server devices 206(1)-206 (n) operates to manage and/or otherwise coordinate operations of the other network computing devices.

The server devices 206(1)-206 (n) may operate as a plurality of network computing devices within a cluster architecture, a peer-to peer architecture, virtual machines, or within a cloud architecture. Thus, the technology disclosed herein is not to be construed as being limited to a single environment and other configurations and architectures are also envisaged.

The plurality of client devices 204(1)-204 (n) may also be the same or similar to the computer system 102 or the computer device 120 as described with respect to FIG. 1, including any features or combination of features described with respect thereto. For example, the client devices 204(1)-204 (n) in this example may include any type of computing device that can interact with the MMIT device 202 via communication network(s) 210. Accordingly, the client devices 204(1)-204 (n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 204 is a wireless mobile communication device, i.e., a smart phone.

The client devices 204(1)-204 (n) may run interface applications, such as standard web browsers or standalone client applications, which may provide an interface to communicate with the MMIT device 202 via the communication network(s) 210 in order to communicate user requests and other information. The client devices 204(1)-204 (n) may further include, among other features, a display device, such as a display screen or touchscreen, and/or an input device, such as a keyboard, for example. The client devices 204(1)-204 (n) may host one or more applications that are proprietary to an enterprise that may be secured against eavesdropping, and these applications may be distributed among client devices 204(1)-204 (n). The enterprise's distributed applications may include software that is based on microservices architecture, for example.

Although the network environment 200 with the MMIT device 202, the client devices 204(1)-204 (n), the server devices 206(1)-206 (n), the databases 208(1)-208 (n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the MMIT device 202, the client devices 204(1)-204 (n), the server devices 206(1)-206 (n), and the databases 208(1)-208 (n), for example, may be configured to operate as virtual instances on the same physical machine. In other words, one or more of the MMIT device 202, the server devices 206(1)-206 (n), the client devices 204(1)-204 (n), and the databases 208(1)-208 (n) may operate on a common physical device rather than as separate devices communicating through communication network(s) 210. Additionally, there may be more or fewer client devices 204(1)-204 (n), server devices 206(1)-206 (n), and databases 208(1)-208 (n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

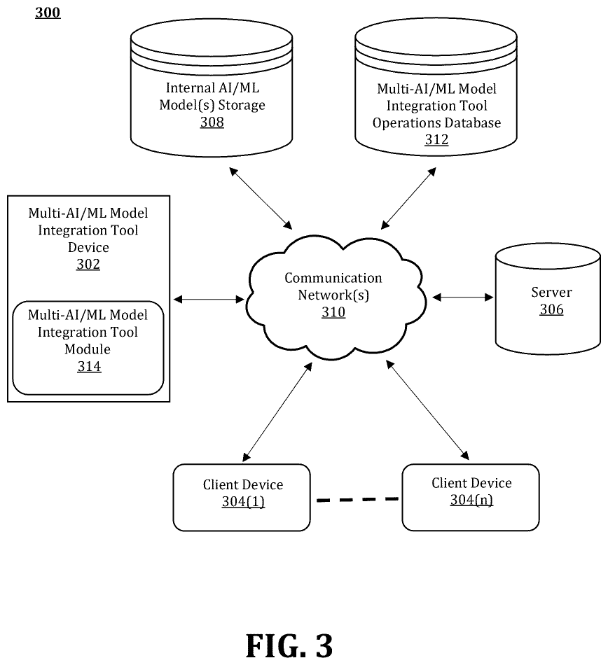

The MMIT device 302 is described and illustrated in FIG. 3 as including multi-AI/ML model integration tool module 314, although it may include other rules, policies, modules, databases, or applications, for example. As will be described below, multi-AI/ML model integration tool module 314 is configured to provide transmission type-based structural conformity to electronic transmissions within at least one electronic transmission network, such as communication network(s) 310, for example. Multi-AI/ML model integration tool module 314 may include software that is based on microservices architecture, for example.

Multi-AI/ML model integration tool module 314 may be integrated with one or more devices or apparatuses, such as client devices 304(1)-304 (n), where multi-AI/ML model integration tool module 314 may be implemented as an application or as an addon or plugin to another application of the one or more devices or apparatuses, and where multi-AI/ML model integration tool module 314 may execute in the background.

A configuration 300 for applying a multi-AI/ML model integration tool to an aspect of the network environment of FIG. 2 is illustrated as being executed in FIG. 3. Specifically, client devices 304(1)-304 (n) are illustrated as being in communication with MMIT device 302. In this regard, a first client device 304(1) and at least a second client device 304(2) may be “clients” of the MMIT device 302 and are described herein as such. Nevertheless, it is to be known and understood that client device 304(1) and/or at least client device 304(2) need not necessarily be “clients” of the MMIT device 302, or any entity described in association therewith herein. Any additional or alternative relationship may exist between client device 304(1), client device 304(2) and MMIT device 302.

Multi-AI/ML model integration tool module 314 of MMIT device 302 may communicate with at least one database, such as an internal AI/ML model(s) storage 308. Thereby, MMIT device 302 may utilize internal AI/ML model(s) storage 308 to store internal AI/ML model(s) and/or their respective training datasets. In addition, multi-AI/ML model integration tool module 314 of MMIT device 302 may also communicate with a multi-AI/ML model integration tool operations database 312. Thereby, MMIT device 302 may obtain multi-AI/ML model integration tool operating parameters from multi-AI/ML model integration tool operations database 312.

In an embodiment, multi-AI/ML model integration tool module 314 may be configured to provide a dynamically customizable interface for selecting, to communicate with, at least one server device at least one from among server devices 306(1)-306 (n). Moreover, MMIT device 302 may receive and transmit data via communication network(s) 210. MMIT device 302 may receive and transmit data such as code that is written in one or more of the following dialects: transaction control language (TCL), data manipulation language (DML), data control language (DCL) and data definition language (DFL). Additionally, via communication network(s) 310, MMIT device 302 may respectively receive and transmit data from and to one or more from among client devices 304(1)-304 (n) and the server devices 306(1)-306 (n).

However, FIG. 3 depicts client device 304(1) and at least client device 304 (n) as belonging to communication network(s) 310, and MMIT device 302 may communicate with any one or more devices or apparatuses that belong to the communication network(s) 310, such as one or more from among client devices 304(1)-304 (n). For example, MMIT device 302 may utilize a graphical user interface (GUI) to communicate with one or more from among client devices 304(1)-304 (n), and communication network(s) 310 may comprise a cluster that belongs to the above-mentioned enterprise that may be secured against eavesdropping. In a further embodiment, communication network(s) 310 may comprise a cluster of distributed applications that belong to the enterprise.

Client device 304(1) may be, for example, a smart phone. Of course, client device 304(1) may be any additional device described herein. Client device 304 (n) may be, for example, a personal computer (PC). Of course, client device 304 (n) may also be any additional device described herein.

The client devices 304(1)-304 (n) may represent, for example, computer systems of the enterprise's client network. Client device 304(1) may represent, for example, one or more computer systems of a client or of a cluster of clients within the enterprise or client network. Of course, client device 304(1) may include one or more of any of the devices described herein. Client device 304 (n) may be, for example, one or more computer systems of another client or cluster of clients within the enterprise or client network. Of course, client device 304 (n) may include one or more of any of the devices described herein.

The process may be executed via the communication network(s) 310, which may comprise plural networks as described above. For example, in an embodiment, either or both of client device 304(1) and client device 204 (n) may communicate with the MMIT device 302 via broadband or cellular communication. Of course, these embodiments are merely exemplary and are not limiting or exhaustive.

Multi-AI/ML model integration tool module 314 may programmatically configure and communicate with server devices 306(1)-306 (n), which may respectively correspond to remote clusters of server devices, such as a server farm, for example.

Multi-AI/ML model integration tool module 314 may execute a process that programmatically configures and communicates with one or more server devices from among server devices 306(1)-306 (n). In some embodiments, at least one (and possibly each) from among server devices 306(1)-306 (n) may comprise a processing platform that may be based on at least one AI/ML model, such as at least one from among at least one large language model (LLM), at least one neural network, and at least one generative AI/ML model.

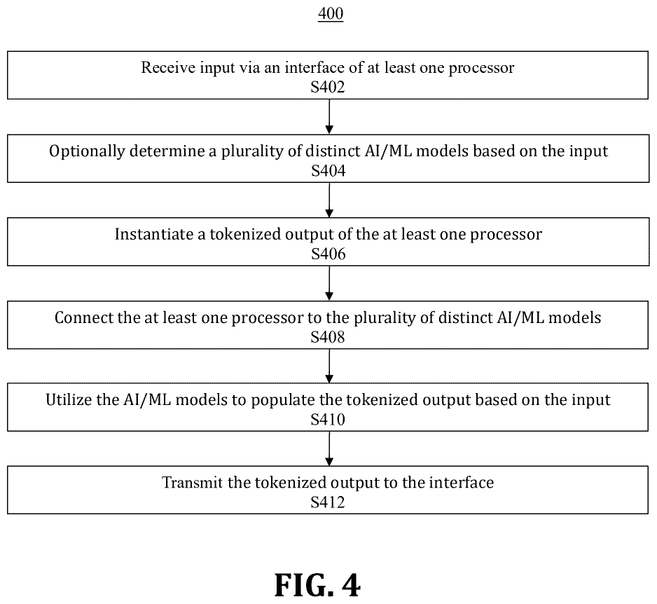

A process for a multi-AI/ML model integration tool is generally indicated at flowchart 400 in FIG. 4. Process 400 may be performed to optimally integrate a plurality of distinct AI/ML models into a cohesive AI/ML paradigm that improves overall quality and scope of the plurality of distinct AI/ML models. Process 400 may be implemented by a multi-AI/ML model integration tool to improve existing AI/ML technology by integrating the plurality of distinct AI/ML models into the cohesive AI/ML paradigm.

At step S402, the multi-AI/ML model integration tool (such as multi-AI/ML model integration tool 202, multi-AI/ML model integration tool device 302 and/or multi-AI/ML model integration tool module 314) may receive an input via an interface of the multi-AI/ML model integration tool. The input may be received by the multi-AI/ML model integration tool, at step S402, from an external processor such as that of at least one client from among a set of client devices, such as client device 304(1) from among client devices 304(1)-304 (n).

Step S402 may be triggered by at least one user of a client device: (1) when the input is transmitted from the client device(s) to the multi-AI/ML model integration tool by the at least one user; or (2) when the multi-AI/ML model integration tool intercepts the at least one user's transmission of the input from the client device(s) to at least one from among the plurality of distinct AI/ML models.

Although the at least one user may transmit the input as an individual request, the multi-AI/ML model integration tool's input may also comprise a plurality of requests transmitted by the at least one user (or a plurality of individual users). Accordingly, the multi-AI/ML model integration tool's input may comprise a plurality of individual requests from individually corresponding users. Although these requests may be embodied within a textual string, the requests are not limited to such embodiments and may also be embodied within an audio, video and/or pictorial electronic file and/or electronic transmission, etc. Additionally, one or more of the input's requests may comprise at least one electronic query.

At step S404, the multi-AI/ML model integration tool may determine the plurality of distinct AI/ML models based on the input. More particularly, at step S404, the multi-AI/ML model integration tool may determine the plurality of distinct AI/ML models by evaluating attributes of the input and comparing those attributes against AI/ML attributes (which may include capabilities) that are associated with the totality of AI/ML models that are available to the multi-AI/ML model integration tool.

Thereby, at step S404, the multi-AI/ML model integration tool may utilize its input to select the plurality of distinct AI/ML models from among the totality of available AI/ML models. In this manner, the multi-AI/ML model integration tool may select a plurality of distinct AI/ML models that are capable of processing the input. Each AI/ML model from among the plurality of distinct AI/ML models may respectively correspond to a distinct server from among a set of servers, which may be represented as server 306. The set of servers (or server 306) may comprise at least one server from among a plurality of server devices, such as server devices 206(1)-206 (n).

In other words, each server from among the plurality of server devices may respectively correspond to a distinct AI/ML model from among the plurality of distinct AI/ML models. Additionally, each distinct AI/ML model from among the plurality of distinct AI/ML models may be stored within a respectively corresponding database from among a plurality of database devices, such as database devices 208(1)-208 (n) and internal AI/ML model(s) storage 308.

At step S406, the multi-AI/ML model integration tool may instantiate a tokenized output of the multi-AI/ML model integration tool. The multi-AI/ML model integration tool may utilize the tokenized output to cache (or otherwise store) processing results of the input (which may comprise caching/storing results of processing one or more queries of the input).

Process 400 depicts step S406 as occurring after step S404. However, it should be noted that step S406 is not limited to this sequence. Rather, it is understood that the operations of step S406 may also be performed prior to step S402, S404 or S410 instead.

At step S408, the multi-AI/ML model integration tool may establish a connection with every AI/ML model from among the plurality of distinct AI/ML models. More particularly, during step S408, the multi-AI/ML model integration tool may establish one or more connections with the plurality of distinct AI/ML models.

Indeed, each AI/ML model from among the plurality of distinct AI/ML models may respectively correspond to a distinct connection from among the one or more connections (a “set of connections”) that may be established by the multi-AI/ML model integration tool during step S408. Accordingly, during step S408, the multi-AI/ML model integration tool may establish a one-to-one correspondence between the plurality of distinct AI/ML models and a plurality of respectively corresponding connections.

At step S410, the multi-AI/ML model integration tool may perform an iterative sequence that utilizes the plurality of connections to populate the tokenized output based on the input. More particularly, during step S410, the multi-AI/ML model integration tool may perform an iterative sequence that is comprised of providing, obtaining, evaluating and updating operations.

In process 400, initial operations of the iterative sequence may comprise providing (via each connection from among the plurality of connections established during step S408) the multi-AI/ML model integration tool's input and the tokenized output's content, to each AI/ML model from among the plurality of distinct AI/ML models. Initially, the tokenized output may not contain any data (i.e., content). However, subsequent iterations of the iterative sequence may update the tokenized output's content with the preceding iteration's results.

After the multi-AI/ML model integration tool's input and tokenized output content (the content of the tokenized output) are received, each distinct AI/ML model from among the plurality of distinct AI/ML models may utilize the input and tokenized output content to generate a respectively corresponding tokenized response.

Each respectively corresponding tokenized response may comprise a set of tokenized response tokens that comprises at least one tokenized response token. In other words, in response to receiving the input and tokenized output content, from the multi-AI/ML model integration tool, the plurality of distinct AI/ML models may generate a set of respectively corresponding tokenized responses to the input.

Accordingly, in response to the input and tokenized output, the multi-AI/ML model integration tool may utilize the processing capabilities of the plurality of distinct AI/ML models to generate the set of respectively corresponding tokenized responses. After the plurality of distinct AI/ML models generate the set of respectively corresponding tokenized responses, each AI/ML model from among the plurality of distinct AI/ML models may utilize a corresponding connection from among the set of connections, to provide a respectively corresponding tokenized response to the multi-AI/ML model integration tool.

Thereby, in process 400, subsequent operations of the iterative sequence may comprise respectively obtaining a distinct corresponding tokenized response (collectively, the set of respectively corresponding tokenized responses) from each AI/ML model among the plurality of distinct AI/ML models. Thereafter, the multi-AI/ML model integration tool's iterative sequence may evaluate the set of respectively corresponding tokenized responses to select a most qualified token from among the set of respectively corresponding tokenized response's various tokens. For the purposes of the present disclosure, a token may comprise an individual term such as a word. However, the present disclosure's tokens are not limited to such embodiments.

In process 400, the iterative sequence's evaluation (of the set of respectively corresponding tokenized responses) may utilize a reinforcement learning mechanism. More particularly, the multi-AI/ML model integration tool's iterative sequence may have a reinforcement learning mechanism utilize reinforcement learning to evaluate the set of respectively corresponding tokenized responses.

In process 400, a reinforcement learning mechanism (such as the reinforcement learning mechanism discussed above) may evaluate every respectively corresponding tokenized response from among the set of respectively corresponding tokenized responses. Hence, the multi-AI/ML model integration tool's iterative sequence may utilize reinforcement learning to determine a respectively corresponding qualitative value for at least one token from among each respectively corresponding tokenized response.

Accordingly, the multi-AI/ML model integration tool may utilize reinforcement learning to determine a plurality of qualitative values that quantify a respectively corresponding quality of at least one token from among each respectively corresponding tokenized response that is obtained from the plurality of distinct AI/ML models.

Each respectively corresponding quality (from among the plurality of qualitative values that are determined by the multi-AI/ML model integration tool's reinforcement learning) may be based on at least one from among: (i) the at least one token from among each respectively corresponding tokenized response within the set of respectively corresponding tokenized responses; and (ii) the content(s) of the multi-AI/ML model integration tool's tokenized output. Thereby, after obtaining the set of respectively corresponding tokenized responses, the multi-AI/ML model integration tool may utilize reinforcement learning to determine each qualitative value from among the plurality of qualitative values.

According to the present disclosure, the multi-AI/ML model integration tool may determine each qualitative value from among the plurality of qualitative values, by performing a quantifying function (Q*), which may be defined by the equation:

$$\text{?} ( s , a ) = \text{?} [ \text{?} ] ,$$

$$\text{?} \text{indicates text missing or illegible when filed}$$

where (i) j represents a jth instance of Q* from among a plurality of instances that respectively correspond to the plurality of distinct AI/ML models, (ii) πⱼ represents a jth AI/ML model from among the plurality of distinct AI/ML models, (iii) s represents the tokenized output, (iv) a represents a proposed token of a jth tokenized response that has been generated by the jth AI/ML model in response to the providing, (v) [symbol] represents an expectation operator, (vi) r* represents an accuracy of an optimal response to the input, (vii) τ represents a trajectory of tuples that comprise at least one state, at least one action and at least one reward, and (viii) ρⱼ represents a distribution of τ.

Moreover, it should also be noted that according to the present disclosure, the term jth is a variable that identifies a particular instance of an element from among a plurality of instances of that element. Additionally, the term jth may also represent an enumeration (such as first, second, third, etc.) that identifies the particular instance of the element from among the plurality of instances.

Thereby, the multi-AI/ML model integration tool may utilize reinforcement learning to determine the plurality of qualitative values by performing a quantifying function, such as Q*, to produce each respectively corresponding quality of the at least one token from among each respectively corresponding tokenized response that is within the set of respectively corresponding tokenized responses.

In addition, the evaluation of the multi-AI/ML model integration tool's iterative sequence may also comprise ranking the at least one token from among each respectively corresponding tokenized response within the set of respectively corresponding tokenized responses. Accordingly, the iterative sequence's evaluation may rank (from highest to lowest) the quality of the at least one token from among each respectively corresponding tokenized response, based on the plurality of qualitative values.

Thereafter, the evaluation of the multi-AI/ML model integration tool's iterative sequence may utilize its ranking of at least one token from among each respectively corresponding tokenized response, to determine a most qualified token from among a set of tokens that comprises the least one token from among each respectively corresponding tokenized response. In the determination, each token from among the set of tokens may correspond to a respective qualitative value from among the plurality of qualitative values.

Based on this evaluation, the multi-AI/ML model integration tool's iterative sequence may update the tokenized output of the multi-AI/ML model integration tool by inserting the most qualified token (from among a set of tokens) into the tokenized output or by adding (e.g., appending) the most qualified token to the tokenized output's content(s). Accordingly, the multi-AI/ML model integration tool's tokenized output may serve as a cache of a set of most qualified tokens that each respectively correspond to a distinct iteration of the iterative sequence.

After each update of the iterative sequence, the multi-AI/ML model integration tool may determine whether the update completes the tokenized output. More particularly, after each update of the iterative sequence, the multi-AI/ML model integration tool may determine whether the most qualified token (of the iterative process's most recent iteration) comprises an end statement.

In the iterative process, an “end statement” may refer to an indication that the most recent iteration is the iterative sequence's final iteration for the input based on the tokenized output's content(s) and/or that the most qualified token concludes the multi-AI/ML model integration tool's populating of the tokenized output based on the input. When the iterative process's update does not complete the tokenized output, the multi-AI/ML model integration tool may perform a subsequent iteration of the iterative sequence until the subsequent iteration's most qualified token completes the tokenized output (and/or comprises an end statement).

Therefore, when the iterative process's update completes the tokenized output (and/or comprises an end statement), process 400 may proceed to step S412 and, at step S412, the multi-AI/ML model integration tool may transmit the content(s) of the tokenized output to an interface —e.g., an application programing interface (API), a graphical user interface (GUI), etc.—of the multi-AI/ML model integration tool. However, according to the present disclosure, the content(s) of the tokenized output may also be transmitted to the interface after each update of the iterative process and, thereby, the iterative sequence may provide progressive updates to the multi-AI/ML model integration tool's interface.

Accordingly, process 400 may be performed by the multi-AI/ML model integration tool to optimally integrate a plurality of distinct AI/ML models into a cohesive AI/ML paradigm that improves overall quality and scope of the plurality of distinct AI/ML models.

The trajectory described herein may comprise a data structure of the form τ={sᵤ, aᵤ, rᵤ}_{u≤t}, which concatenates past tokenized responses sᵤ={sₖ}_{k≤u}, selected tokens according to policy aᵤ~πⱼ(sᵤ), and rᵤ which may represent the reward associated with the jth constituent policy πⱼ. The input variable mentioned above may be trajectory data τ and the distribution may be ρⱼ. Also, expectation operator [symbol] may utilize both a scalar-ranged function and a distribution, as input. Subsequently, the expectation operator [symbol] may return a result equal to the scalar-ranged function's average value over the scalar-ranged function's range.

The present disclosure introduces the novel concept of multi-agent alignment in the context of decoding as a potential solution for better generalization to a target preference or task. In such a setup, a set of specialized policies may be represented as Π={π₁, π₂ ⋅ ⋅ ⋅ πₖ} aligned to a diverse set of tasks and preferences. Personalized preferences or tasks can be captured using specific reward functions, and the corresponding reward functions of the above policies may be represented by the set R={r₁, r₂ ⋅ ⋅ ⋅ rₖ}.

Under this context and scenario, multi-agent alignment may efficiently adapt to a target preference or task represented through a target reward function r_{target} based on the above-aligned policies/agents. To optimally perform multiagent alignment, the present disclosure addresses policy selection optimization based on a target task or preference of the above-mentioned context and scenario.

Additionally, to optimally perform multiagent alignment, the present disclosure presents an approach to determining the optimal metric for (i) selecting at least one agent from among a plurality of agents and (ii) performing principled decoding.

Token-level Markov decision process (MDP). According to the present disclosure, token-level MDP may be define in the context of AI/ML models (e.g., LLMs) by formulating the decoding problem as a KL regularized reinforcement learning problem with the token-level MDP M:={S, A, P, R} with the state-space S represents the concatenated sequence of tokens and the action space A representing the space of the next token, i.e., vocabulary V. Given a state sₜ=[x, y_{≤t}]∈S, which is a sequence of tokens containing the prompt/query x:={x₁, x₂, ⋅ ⋅ ⋅ , x_{N}} appended with the t tokens y_{<t}:={y₀, y₁, ⋅ ⋅ ⋅ , yₜ₋₁} generated so far, an AI/ML model (e.g., an LLM) is a policy π that generates the action (i.e., the next token) aₜ=yₜ via sampling from the token-level decoding policy yₜ~π(·|sₜ). The transition P to the next state sₜ₊₁ is deterministic: sₜ₊₁=[x, y_{≤t}, yₜ], the concatenation of the current state and action. The trajectory level probability by

$${ρ}_{π} ( \vert ) = {\prod }_{1 = 1}^{T} π ( {y}_{t} \vert [ {,}_{< t} ] ) .$$

The token-level reward R(x, yₜ) from the trajectory level reward model r(x, y) as follows:

$$R ( x , {y}_{t} ) := \{ \begin{matrix}0 , y \neq EOS \\ r ( x , {y}_{\leq t} ) y = EOS\end{matrix} , \qquad ( 1 )$$

where EOS∈V represents the end of sequence token. The token level reward in equation (1) implies a reward may only be received once we have the full sequence/response, otherwise, no reward is assigned to each token.

Provable transfer with multiagent decoding for alignment can efficiently adapt to a new reward r_{target} based on available reward models and policy. Q^{π}₁, Q^{π}₂, Q^{π}₃ ⋅ ⋅ ⋅ Q^{π}ₖ may be the action value functions for the policies under the reward {r₁, r₂ ⋅ ⋅ ⋅ rₖ} respectively.

In the present disclosure, an algorithm's policy may be defined by the equation:

$${π}_{a l g} ∈ arg {max}_{a} max {J}_{*}^{π j} ( s , a ) \qquad ( 2 )$$

where,

$${J}_{*}^{π j} ( s , a ) = {Q}_{*}^{π j} ( s , a ) - α K L ( {π}_{j} ( \cdot \vert s ) , {π}_{SFT} ( \cdot \vert s ) ) .$$

An implicit Q-function may be defined as a maximum value of the objective over all the agents and the objective may be represented by the equation:

$${π}_{a l g} ∈ arg {max}_{a} {Q}_{*}^{i m p} ( s , a ) \qquad ( 3 )$$

Thereby, to strengthen a target task's test-time performance, a mixture of agents-based decoding strategies may be utilized to leverage aligned AI/ML policies off-the-shelf since single-agent decoding approaches can struggle to adapt to the complexity and variability that are inherent to diverse tasks. Accordingly, each existing AI/ML policy may serve as an agent within a collaboration (of agents) to provide a decoding method that enables inference-time alignment through a token-level selection strategy among multiple agents as described above and as described in further detail by the appendix to the present disclosure.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method that optimally integrates a plurality of distinct artificial intelligence and machine learning (AI/ML) models into a cohesive AI/ML paradigm that improves an overall quality and scope of the plurality of distinct AI/ML models, the method comprising:
receiving an input via an interface of at least one processor;
instantiating a tokenized output of the at least one processor;
establishing, with the at least one processor, a plurality of connections that respectively correspond to and communicate with each AI/ML model from among the plurality of distinct AI/ML models;
performing, by the at least one processor, an iterative sequence that utilizes the plurality of connections to populate the tokenized output based on the input; and
transmitting the tokenized output to the interface.

2. The method of claim 1, wherein the iterative sequence comprises:
providing, via each connection from among the plurality of connections, the input and the tokenized output to each AI/ML model from among the plurality of distinct AI/ML models;
obtaining, from each AI/ML model via a respectively corresponding connection from among the plurality of connections, a respectively corresponding token of a respectively corresponding tokenized response that has been generated, in response to the providing, by a respectively corresponding AI/ML model from among the plurality of distinct AI/ML models;
evaluating the input, the tokenized output, and a set of tokens that comprises each respectively corresponding token, to determine a most qualified token from among the set of tokens; and
updating, by appending the most qualified token to, the tokenized output.

3. The method of claim 2, further comprising:
when the at least one processor determines that the updating does not complete the tokenized output, re-performing the iterative sequence until the at least one processor determines that the updating completes the tokenized output,
wherein the iterative sequence further comprises analyzing the input, the tokenized output, and each respectively corresponding tokenized response to determine, via the at least one processor, whether the updating completes the tokenized output.

4. The method of claim 2, wherein the iterative sequence further comprises:
responding to each updating by transmitting, to the interface, at least one from among the most qualified token and the tokenized output.

5. The method of claim 2,
wherein each respectively corresponding tokenized response is at least textual, and
wherein each respectively corresponding token comprises a respectively corresponding textual term from among the respectively corresponding tokenized response.

6. The method of claim 5, wherein the updating completes the tokenized output when the most qualified token comprises an end statement.

7. The method of claim 2, wherein the evaluating comprises utilizing a reinforcement learning mechanism to determine, for each token from among the set of tokens, a respectively corresponding qualitative value of the token.

8. The method of claim 7, wherein the reinforcement learning mechanism determines each respectively corresponding qualitative value by performing a quantifying function (Q*) that is defined by the equation:
$$\text{?} ( s , a ) = \text{?} [ \text{?} ] ,$$
$$\text{?} \text{indicates text missing or illegible when filed}$$
wherein j represents a jth instance of Q* from among a plurality of instances that respectively correspond to the plurality of distinct AI/ML models,
πⱼ represents a jth AI/ML model from among the plurality of distinct AI/ML models,
s represents the tokenized output,
a represents a proposed token of a jth tokenized response that has been generated by the jth AI/ML model in response to the providing, [symbol]
represents an expectation operator,
r* represents an accuracy of an optimal response to the input,
τ represents a trajectory of tuples that comprise at least one state, at least one action and at least one reward, and
ρⱼ represents a distribution of τ.

9. The method of claim 1, wherein the plurality of distinct AI/ML models comprise at least one large language model (LLM).

10. The method of claim 1, further comprising determining, based on the input, the plurality of distinct AI/ML models.

11. A system that optimally integrates a plurality of distinct artificial intelligence and machine learning (AI/ML) models into a cohesive AI/ML paradigm that improves an overall quality and scope of the plurality of distinct AI/ML models, the system comprising:
a processor that is coupled to an interface; and
memory storing instructions that, when executed by the processor, cause the processor to perform operations comprising:
receiving an input via the interface;
instantiating a tokenized output;
establishing a plurality of connections that respectively correspond to and communicate with each AI/ML model from among the plurality of distinct AI/ML models;
performing an iterative sequence that utilizes the plurality of connections to populate the tokenized output based on the input; and
transmitting the tokenized output to the interface.

12. The system of claim 11, wherein when executed by the processor, the instructions cause the iterative sequence to comprise:
providing, via each connection from among the plurality of connections, the input and the tokenized output to each AI/ML model from among the plurality of distinct AI/ML models;
obtaining, from each AI/ML model via a respectively corresponding connection from among the plurality of connections, a respectively corresponding token of a respectively corresponding tokenized response that has been generated, in response to the providing, by a respectively corresponding AI/ML model from among the plurality of distinct AI/ML models;
evaluating the input, the tokenized output, and a set of tokens that comprises each respectively corresponding token, to determine a most qualified token from among the set of tokens; and
updating, by appending the most qualified token to, the tokenized output.

13. The system of claim 12, wherein when executed, the instructions cause the processor to perform further operations comprising:
when the at least one processor determines that the updating does not complete the tokenized output, re-performing the iterative sequence until the at least one processor determines that the updating completes the tokenized output, and
wherein the instructions cause the iterative sequence to further comprise analyzing the input, the tokenized output, and each respectively corresponding tokenized response to determine, via the at least one processor, whether the updating completes the tokenized output.

14. The system of claim 12, wherein when executed by the processor, the instructions cause the iterative sequence to further comprise:
responding to each updating by transmitting, to the interface, at least one from among the most qualified token and the tokenized output.

15. The system of claim 12, wherein when executed by the processor, the instructions cause:
each respectively corresponding tokenized response to be at least textual, and
each respectively corresponding token to comprise a respectively corresponding textual term of the respectively corresponding tokenized response.

16. The system of claim 15, wherein when the instructions are executed by the processor, the updating completes the tokenized output when the most qualified token comprises an end statement.

17. The system of claim 12, wherein when the instructions are executed by the processor, the evaluating comprises utilizing a reinforcement learning mechanism to determine, for each token from among the set of tokens, a respectively corresponding qualitative value of the token.

18. The system of claim 17, wherein when the instructions are executed by the processor, the reinforcement learning mechanism determines each respectively corresponding qualitative value by performing a quantifying function (Q*) that is defined by the equation:
$$\text{?} ( s , a ) = \text{?} [ \text{?} ] ,$$
$$\text{?} \text{indicates text missing or illegible when filed}$$
wherein j represents a jth instance of Q* from among a plurality of instances that respectively correspond to the plurality of distinct AI/ML models,
πⱼ represents a jth AI/ML model from among the plurality of distinct AI/ML models,
s represents the tokenized output, [symbol]
represents an expectation operator,
a represents a proposed token of a jth tokenized response that has been generated by the jth AI/ML model in response to the providing,
r* represents an accuracy of an optimal response to the input,
τ represents a trajectory of tuples that comprise at least one state, at least one action and at least one reward, and
ρⱼ represents a distribution of τ.

19. A non-transitory computer-readable medium that optimally integrates a plurality of distinct artificial intelligence and machine learning (AI/ML) models into a cohesive AI/ML paradigm that improves an overall quality and scope of the plurality of distinct AI/ML models, wherein the computer-readable medium stores instructions that, when executed by a processor, cause the processor to perform operations comprising:
receiving an input via the interface;
instantiating a tokenized output;
establishing a plurality of connections that respectively correspond to and communicate with each AI/ML model from among the plurality of distinct AI/ML models;
performing an iterative sequence that utilizes the plurality of connections to populate the tokenized output based on the input; and
transmitting the tokenized output to the interface.

20. The computer-readable medium of claim 19, wherein when executed by the processor, the instructions cause the iterative sequence to comprise:
providing, via each connection from among the plurality of connections, the input and the tokenized output to each AI/ML model from among the plurality of distinct AI/ML models;
obtaining, from each AI/ML model via a respectively corresponding connection from among the plurality of connections, a respectively corresponding token of a respectively corresponding tokenized response that has been generated, in response to the providing, by a respectively corresponding AI/ML model from among the plurality of distinct AI/ML models;
evaluating the input, the tokenized output, and a set of tokens that comprises each respectively corresponding token, to determine a most qualified token from among the set of tokens; and
updating, by appending the most qualified token to, the tokenized output.
